(19) United States
(12) Patent Application Publication
(10) Pub. No.: US 2013/0209895 A1
(43) Pub. Date: Aug. 15, 2013

(54) RECHARGEABLE LITHIUM BATTERY

(71) Applicants: Ji-Young Kim, Yongin-si (KR); Wan-Mook Lim, Yongin-si (KR); Myoung-Han Ryu, Yongin-si (KR); Hyun-Ki Jung, Yongin-si (KR); Hyo-Rim Bak, Yongin-si (KR)

(72) Inventors: Ji-Young Kim, Yongin-si (KR); Wan-Mook Lim, Yongin-si (KR); Myoung-Han Ryu, Yongin-si (KR); Hyun-Ki Jung, Yongin-si (KR); Hyo-Rim Bak, Yongin-si (KR)

(73) Assignee: SAMSUNG SDI CO., LTD., Yongin-si (KR)

(21) Appl. No.: 13/604,128

(22) Filed: Sep. 5, 2012

(30) Foreign Application Priority Data
Feb. 15, 2012 (KR) 10-2012-0015501

(51) Int. Cl. H01M 10/0568; H01M 4/525; H01M 4/485

(52) U.S. Cl. 429/332; 429/324; 429/341; 429/338; 429/342

(57) ABSTRACT

Disclosed is a rechargeable lithium battery that includes a positive electrode having an active mass density of about 3.4 g/cc to about 4.0 g/cc, a negative electrode, and an electrolyte including a non-aqueous organic solvent including a compound represented by Chemical Formula 1 in an amount of about 10 volume % to about 50 volume % based on the total amount of the non-aqueous organic solvent. Chemical Formula 1: CH₃COO—R¹, wherein R¹ is a C1 to C4 linear or branched alkyl group.

### CLAIM OF PRIORITY

This application makes reference to, incorporates the same herein, and claims all benefits accruing under 35 U.S.C. §119 from, an application for RECHARGEABLE LITHIUM BATTERY earlier filed in the Korean Intellectual Property Office on 15 Feb. 2012 and there duly assigned Serial No. 10-2012-0015501.

### BACKGROUND OF THE INVENTION

1. Field of the Invention

This disclosure relates to a rechargeable lithium battery.

2. Description of the Related Art

Lithium rechargeable batteries have recently drawn attention as a power source of small portable electronic devices. They use an organic electrolyte solution and thereby have twice or more the discharge voltage of a conventional battery using an alkali aqueous solution, and accordingly have high energy density.

A rechargeable lithium battery is made by injecting an electrolyte into a battery cell including a positive electrode including a positive active material that can intercalate and deintercalate lithium and a negative electrode including a negative active material that can intercalate and deintercalate lithium.

The electrolyte is generally prepared by dissolving a lithium salt in an organic solvent. Recently, research on enhancing the active mass density has been conducted in order to increase the capacity of rechargeable lithium batteries, but application to real products is difficult since the cycle-life characteristics are generally remarkably degraded.

### SUMMARY OF THE INVENTION

One embodiment provides a rechargeable lithium battery having excellent cycle-life characteristic and characteristics after being allowed to stand at a high temperature.

According to one embodiment, a rechargeable lithium battery is provided that includes a positive electrode having an active mass density of about 3.4 g/cc to about 4.0 g/cc, a negative electrode, and an electrolyte including a non-aqueous organic solvent including a compound represented by the following Chemical Formula 1 in an amount of about 10 volume % to about 50 volume % based on the total amount of the non-aqueous organic solvent.

CH₃COO—R¹ Chemical Formula 1

In Chemical Formula 1, R¹ is a C1 to C4 linear or branched alkyl group.

The non-aqueous organic solvent may include a compound comprising a carbonate group.

The non-aqueous organic solvent may include one selected from a compound comprising a cyclic carbonate group, a compound comprising a linear carbonate group, and combinations thereof.

The non-aqueous organic solvent may include a cyclic carbonate-based solvent in an amount of less than or equal to about 30 volume % based on the total amount of the non-aqueous organic solvent.

The non-aqueous organic solvent may include a linear carbonate-based solvent in an amount of about 20 volume % to about 90 volume % based on the total amount of the non-aqueous organic solvent.

The carbonate-based solvent may include a cyclic carbonate-based solvent and a linear carbonate-based solvent at a volume ratio of about 1:1 to about 1:9.

The electrolyte may have a viscosity of about 2.90 cP to about 4.45 cP and a conductivity of greater than or equal to about 10 mS/cm.

The positive active material may include lithium-nickel-cobalt-manganese composite metal oxide.

The rechargeable lithium battery may realize excellent cycle-life characteristic and characteristics after being allowed to stand at a high temperature.

### BRIEF DESCRIPTION OF THE DRAWING

FIG. 1 is a schematic view of a rechargeable lithium battery according to one embodiment.

### DETAILED DESCRIPTION OF THE INVENTION

Exemplary embodiments of this disclosure will hereinafter be described in detail. However, these embodiments are only exemplary, and this disclosure is not limited thereto.

The rechargeable lithium battery may include a positive electrode having an active mass density of about 3.4 glee to about 4.0 g/cc, a negative electrode, and an electrolyte including a non-aqueous organic solvent including a compound represented by the following Chemical Formula 1 in an amount of about 10 volume % to about 50 volume % based on the total amount of the non-aqueous organic solvent.

CH₃COO—R¹ Chemical Formula 1

In Chemical Formula 1, R¹ is a C1 to C4 linear or branched alkyl group, for example a C1 to C3 linear or branched alkyl group.

The compound represented by Chemical Formula 1 may include one selected from methyl acetate (MA), ethyl acetate (EA), propyl acetate (PA), butyl acetate, tert-butyl acetate, and combinations thereof, but is not limited thereto.

The electrolyte includes a non-aqueous organic solvent and a lithium salt. The non-aqueous organic solvent acts as a medium for transmitting ions that carry out the electrochemical reaction of a rechargeable lithium battery, and the lithium salt which is dissolved into the non-aqueous organic solvent acts as a source of lithium ions in a rechargeable lithium battery. The solvent and lithium salt accelerate the transmission of lithium ion between the positive electrode and the negative electrode.

Generally, as the properties of the electrode are enhanced as the active mass density of the electrode is increased, the electrolyte may be effectively impregnated into the electrode by decreasing the viscosity of electrolyte. However, when the electrolyte has too low viscosity, the characteristics when allowed to stand at a high temperature may be degraded.

Since the compound represented by Chemical Formula 1 has a low viscosity, the viscosity of an electrolyte may be appropriately decreased by using the non-aqueous organic solvent including the compound represented by Chemical Formula 1 at about 10 volume % to about 50 volume % based on the total amount of non-aqueous organic solvent. Thereby, the electrolyte may be effectively impregnated into the electrode, and the cycle-life characteristics and characteristics when allowed to stand at high temperature may be effectively improved.

The non-aqueous organic solvent may include a carbonate-based solvent. When the non-aqueous organic solvent includes a carbonate-based solvent, the stability may be improved during operation of the battery, which improves battery performance.

The carbonate-based solvent may include one selected from a cyclic carbonate-based solvent, a linear carbonate-based solvent, and combinations thereof.

The cyclic carbonate-based solvent may include one selected from ethylene carbonate (EC), propylene carbonate (PC), butylene carbonate (BC), fluoroethylene carbonate (FEC), vinylethylene carbonate (VEC), and combinations thereof, but is not limited thereto. In one embodiment, the cyclic carbonate may be preferably ethylene carbonate (EC).

The linear carbonate may include one selected from dimethyl carbonate (DMC), diethyl carbonate (DEC), dipropyl carbonate (DPC), ethylmethyl carbonate (EMC), methylpropyl carbonate (MPC), ethylpropyl carbonate (EPC), and combinations thereof, but is not limited thereto. In one embodiment, the linear carbonate may be preferably dimethyl carbonate (DMC).

The non-aqueous organic solvent may include the cyclic carbonate-based solvent in an amount of less than or equal to about 30 volume % based on the total amount of the non-aqueous organic solvent. When the cyclic carbonate-based solvent is included within this range, the viscosity may be decreased to facilitate the transmission of ions. In one embodiment, the non-aqueous organic solvent may include the cyclic carbonate-based solvent in an amount of about 10 volume % to about 30 volume % based on the total amount of the non-aqueous organic solvent.

The non-aqueous organic solvent may include the linear carbonate-based solvent in an amount of about 20 volume % to about 90 volume % based on the total amount of the non-aqueous organic solvent. When the linear carbonate-based solvent is included within this range, the dielectric constant may be increased to effectively enhance the ion conductivity. In one embodiment, the non-aqueous organic solvent may include the linear carbonate-based solvent in an amount of about 80 volume % to about 90 volume % based on the total amount of the non-aqueous organic solvent.

When the carbonate-based solvent includes the cyclic carbonate and the linear carbonate, the cyclic carbonate and the linear carbonate may be mixed in a volume ratio of about 1:1 to about 1:9, which improves performance of an electrolyte. In one embodiment, the cyclic carbonate and the linear carbonate may be mixed in a volume ratio of about 3:7 to about 1:9.

The non-aqueous organic solvent may further include an ester-based solvent, ether-based solvent, ketone-based solvent, alcohol-based solvent, aprotic solvent, or aromatic hydrocarbon-based solvent, but is not limited thereto.

The ester-based solvent may include methylpropionate, ethylpropionate, γ-butyrolactone, decanolide, valerolactone, mevalonolactone, caprolactone, and the like.

The ether-based solvent may include dimethyl ether, dibutyl ether, tetraglyme, diglyme, dimethoxyethane, 2-methyltetrahydrofuran, tetrahydrofuran (THF), and the like.

The ketone-based solvent may include cyclohexanone and the like.

The alcohol-based solvent may include ethanol, isopropylalcohol, and the like.

The aprotic solvent may include R nitriles such as R—CN (wherein R is a C2 to C20 linear, branched or a cyclic hydrocarbon group, and may include a double bond, an aromatic ring, or an ether bond), amides such as dimethylformamide (DMF), dimethyl acetamide (DMAC), ands the like, and dioxolanes such as 1,3-dioxolane, sulfolanes, cycloalkanes such as cyclohexane, and the like.

The aromatic hydrocarbon-based solvent may include an aromatic hydrocarbon-based compound represented by the following Chemical Formula 2.

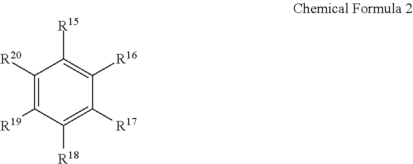

In Chemical Formula 2, R¹⁵ to R²⁰ are the same or different, and are each independently selected from hydrogen, a halogen, a C1 to C10 alkyl group, a C1 to C10 haloalkyl group, and combinations thereof.

The aromatic hydrocarbon-based solvent may include one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous organic solvent may be used singularly or in a mixture. When the organic solvent is used in a mixture, its mixture ratio may be controlled in accordance with desirable performance of a battery.

The lithium salt may include one selected from LiPF₆, LiBF₄, LiSbF₆, LiAsF₆, LiCF₃SO₃, LiN (SO₂C₂F₅)₂, LiN(SO₂CF₃)₂, LiN(SO₃C₂F₅)₂, LiC₄F₉SO₃, LiClO₄, LiAlO₄, LiAlO₂, LiAlCl₄, LiN (CₓF₂ₓ₊₁SO₂)(C_{y}F_{2y+1}S₂) (wherein, x and y are natural numbers), LiCl, LiI, LiB(C₂O₄)₂ (lithium bis(oxalato) borate, LiBOB), and combinations thereof, but is not limited thereto.

The lithium salt may act as a supporting electrolytic salt.

The lithium salt may be included in a concentration of about 0.1 M to about 2.0 M, specifically about 0.5 M to about 2.0 M. When the lithium salt is included within the above concentration range, an electrolyte may have optimal electrolyte conductivity and viscosity, and thus excellent performance and lithium ion mobility.

The electrolyte may have a viscosity of about 2.90 cP to about 4.45 cP. When the viscosity of the electrolyte is within the above range, the ions may be easily transferred.

The electrolyte may have conductivity of greater than or equal to about 10 mS/cm. When the electrolyte has a conductivity within this range, the ion conductivity may be effectively improved. In one embodiment, the electrolyte may have a conductivity of about 10 MS/CM to about 13 mS/cm, and specifically, about 10.5 mS/cm to about 13 mS/cm.

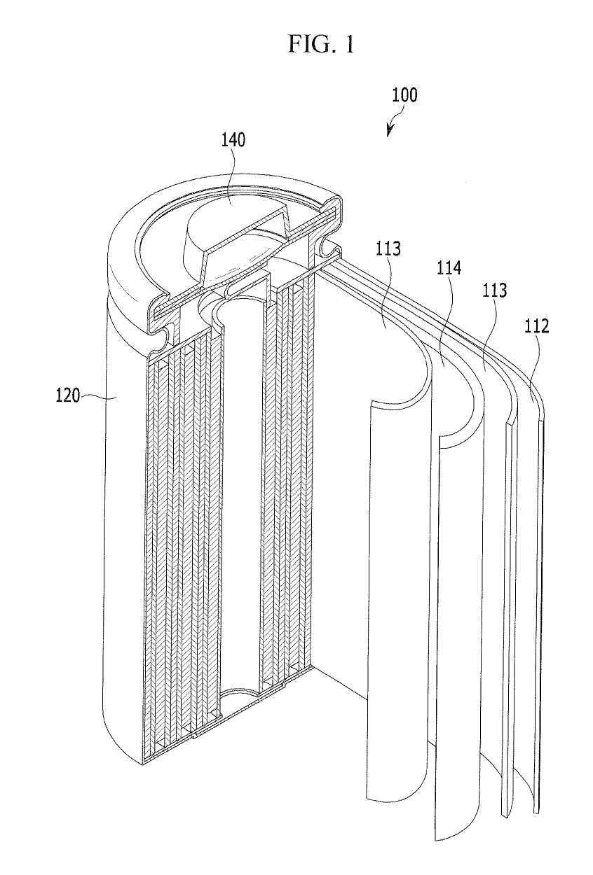

Hereinafter, a rechargeable lithium battery including an electrolyte is described referring to FIG. 1.

FIG. 1 is a schematic view of a rechargeable lithium battery according to one embodiment.

Referring to FIG. 1, the rechargeable lithium battery 100 according to one embodiment includes an electrode assembly including a positive electrode 114, a negative electrode 112 facing the positive electrode 114, a separator 113 disposed between the positive electrode 114 and negative electrode 112, and an electrolyte (not shown) impregnating the positive electrode 114, negative electrode 112, and separator 113, a battery case 120 housing the electrode assembly, and a sealing member 140 sealing the battery case 120.

The positive electrode 114 may include a positive current collector and a positive active material layer disposed on the positive current collector. The positive active material layer includes a positive active material, a binder, and optionally a conductive material.

The positive current collector may include aluminum (Al), but is not limited thereto.

The positive active material includes lithiated intercalation compounds that reversibly intercalate and deintercalate lithium ions.

The positive active material may be one of compounds represented by the following Chemical Formulas, but is not limited thereto:

LiₐA_{1-b}B_{b}D₂ (0.90≦a≦1.8 and 0≦b≦0.5); LiₐE₁₋bB_{b}O_{2-c}D_{c} (0.90≦a≦1.8, 0≦b≦0.5, 0≦c≦0.05); LiE_{2-b}B_{b}O_{4-c}D_{c} (0≦b≦0.5, 0≦c≦0.05); LiₐNi_{1-b-c}Co_{b}BₐD_{α} (0.90≦a≦1.8, 0≦b≦0.5, 0≦c≦0.05, 0≦a≦2); LiₐNi_{1-b-c}Co_{b}BₑO_{2-α}F_{α} (0.90≦a≦1.8, 0≦b≦0.5, 0≦c≦0.05, 0<α≦2); LiₐNi_{1-b-c}Co_{b}B_{c}O_{2-α}F₂ (0.90≦a≦1.8, 0≦b≦0.5, 0≦c<0.05, 0<α<2); LiₐNi_{1-b-c}Mn_{b}B_{c}D_{α} (0.90≦a≦1.8, 0≦b≦0.5, 0≦c≦0.05, 0<α≦2); LiₐNi_{1-b-c}Mn_{b}B_{c}O_{2-α}F_{α} (0.90≦α≦1.8, 0≦b≦0.5, 0≦c≦0.05, 0<α≦2); LiₐNi_{1-b-c}Mn_{b}B_{c}O_{2-α}F₂ (0.90≦α≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d<0.5, 0.001≦e≦0.1); Li_{d}NiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiIO₂; LiNiVO₄; Li_{(3-f)}J₂(PO₄)₃(0≦f≦2); Li_{(3-f)}Fe₂(PO₄)₃(0≦f≦2); and LiFePO₄.

In the above Chemical Formulas, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Se, Y, or a combination thereof; and J is V, Cr, Mn, Co, Ni, Cu, or a combination thereof.

In one embodiment, the positive active material may be preferably lithium-nickel-cobalt-manganese composite metal oxide. In this case, the positive active material may be economically and easily produced and used. In one embodiment, the lithium-nickel-cobalt-manganese composite metal oxide may include the compound represented by the following Chemical Formula 3.

LiₓNi_{y}Co_{z}Mn_{w}Oₜ Chemical Formula 3

In Chemical Formula 3,

0.9≦x≦1.1, specifically x=1;

0.1≦y≦1, specifically 0.3≦y<1, and more specifically 0.5≦y≦0.6;

0.1≦z<1, specifically 0.1≦z≦0.5, and more specifically 0.1≦z≦0.3;

0.1≦w<1, specifically 0.1≦w≦0.5, and more specifically 0.1≦w≦0.3;

1.5≦t≦2.5, specifically t=2; and

y+z+w=1.

The compound represented by Chemical Formula 3 may be LiNi_{0.5}Co_{0.2}Mn_{0.3}O₂, but is not limited thereto.

The compound may be a compound with a coating layer on the surface or a mixture of the active material and the compound with a coating layer thereon. The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. The compound for the coating layer may be either amorphous or crystalline. The coating element included in the coating layer may be Mg, Al, Co, K, Na, Ca, Si, Ti, V, Sn, Ge, Ga, B, As, Zr, or mixtures thereof. The coating process may include any conventional process (unless it causes undesirable side effects on the properties of the positive active material) (e.g., spray coating, immersing), which are well known to those who have ordinary skill in this art and will not be illustrated in further detail.

The binder improves binding properties of the positive active material particles to one another and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinyl idenefluoride, polyethylene, polypropylene, styrene-butadiene rubber, acrylated styrene-butadiene rubber, an epoxy resin, nylon, and the like, but are not limited thereto.

The conductive material improves electrical conductivity of a negative electrode. Any electrically conductive material can be used as a conductive agent unless it causes a chemical change. Examples of the conductive material include at least one selected from a carbon-based material such as natural graphite, artificial graphite, carbon black, Super-P (manufactured by MMM), acetylene black, ketjen black, hard carbon, soft carbon, a carbon fiber, and the like, a metal-based material of a metal powder or a metal fiber including copper, nickel, aluminum, silver, and the like, a conductive polymer such as a polyphenylene derivative, or mixtures thereof.

According to one embodiment, the positive electrode has an active mass density of about 3.4 g/cc to about 4.0 g/cc. When the positive electrode has an active mass density within this range, the capacity of a rechargeable lithium battery may be increased, and the effects of using the electrolyte according to one embodiment may be maximized. Thereby, the rechargeable lithium battery may effectively improve the cycle-life characteristics and the characteristics after being allowed to stand at a high temperature and have a high energy density. In one embodiment, the positive electrode may have an active mass density of about 3.4 g/cc to about 3.8 g/cc.

The negative electrode 112 includes a negative current collector and a negative active material layer disposed on the negative current collector. The negative active material layer includes a negative active material, a binder, and optionally a conductive material.

The negative current collector may include a copper foil, a nickel foil, a stainless steel foil, a titanium foil, a nickel foam, a copper foam, a polymer substrate coated with a conductive metal, and combinations thereof, but is not limited thereto.

The negative active material includes a material that reversibly intercalates/deintercalates lithium ions, a lithium metal, a lithium metal alloy, a material capable of doping/dedoping lithium, or a transition metal oxide.

The material that can reversibly intercalate/deintercalate lithium ions includes a carbon material. The carbon material may be any generally-used carbon-based negative active material in a lithium ion rechargeable battery. Examples of the carbon material include crystalline carbon, amorphous carbon, and mixtures thereof. The crystalline carbon may be non-shaped, or sheet, flake, spherical, or fiber shaped natural graphite or artificial graphite. The amorphous carbon may be a soft carbon, a hard carbon, a mesophase pitch carbonization product, fired coke, and the like.

Examples of the lithium metal alloy include lithium and an element selected from lithium, Na, K, Rb, Cs, Fr, Be, Mg, Ca, Sr, Si, Sb, Pb, In, Zn, Ba, Ra, Ge, Al, Sn, Ti, Ag, Cd, Ga, Bi, and combinations thereof.

The material capable of doping/dedoping lithium may include Si, SiOₓ (0<x<2), a Si—C composite, a Si—Y alloy (wherein Y is selected from an alkali metal, an alkaline-earth metal, Group 13 to Group 16 elements, a transition element, a rare earth element, and combinations thereof, and is not Si), Sn, SnO₂, a Sn—C composite, a Sn—Y alloy (wherein Y is selected from an alkali metal, an alkaline-earth metal, Group 13 to Group 16 elements, a transition element, a rare earth element, and combinations thereof, and is not Sn), and the like. At least one of these materials may be mixed with SiO₂. In addition, the surface may be deposited and coated with carbon. The coating materials with carbon on their surface may be made by decomposing an organic material such as ethylene, tetrahydrofuran (THF), cyclohexanone or the like at a high temperature, for example, greater than or about equal to 800° C. and under vacuum in the presence of these materials, but is not limited thereto. The element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

Examples of the transition metal oxide include vanadium oxide, lithium vanadium oxide, and the like.

The binder improves binding properties of negative active material particles with one another and with a current collector. The binder may include a non-water-soluble binder, a water-soluble binder, or combinations thereof.

The non-water-soluble binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or combinations thereof.

The water-soluble binder may include a styrene-butadiene rubber, an acrylated styrene-butadiene rubber, polyvinylalcohol, sodium polyacrylate, a copolymer of propylene and C2 to C8 olefin, a copolymer of (meth)acrylic acid and (meth)acrylic acid alkylester, or combinations thereof.

When the water-soluble binder is used as a negative electrode binder, a cellulose-based compound may be further used to provide viscosity. The cellulose-based compound includes one or more of carboxylmethyl cellulose, hydroxypropyl cellulose, hydroxypropylmethyl cellulose, diacetyl cellulose, methyl cellulose, or alkaline metal salts thereof. The alkaline metal may be Na, K, or Li. The cellulose-based compound may be included in an amount of about 0.1 to about 3 parts by weight based on 100 parts by weight of the negative active material.

The conductive material is included to improve electrode conductivity. Any electrically conductive material may be used as a conductive material unless it causes a chemical change. Examples of the conductive material include a carbon-based material such as natural graphite, artificial graphite, carbon black, Super-P (manufactured by MMM), acetylene black, ketjen black, hard carbon, soft carbon, a carbon fiber, and the like, a metal-based material such as a metal powder or a metal fiber including copper, nickel, aluminum, or silver, a conductive polymer such as a polyphenylene derivative, or mixtures thereof.

The negative electrode 112 and the positive electrode 114 may be fabricated by a method including mixing an active material, a conductive material, and a binder in a solvent to prepare an active material layer composition, and coating the composition on a current collector. The electrode manufacturing method is well known, and thus is not described in greater detail. The solvent includes N-methylpyrrolidone, water, and the like, but is not limited thereto.

The separator 113 may be formed as a single layer or a multilayer, and may be made of polyethylene, polypropylene, polyvinylidene fluoride, or combinations thereof. However, it is not limited thereto, and the separator may be omitted in the rechargeable lithium battery according to one embodiment.

Rechargeable lithium batteries may be classified as lithium ion batteries, lithium ion polymer batteries, and lithium polymer batteries according to the presence of a separator and the kind of electrolyte used in the battery. The rechargeable lithium batteries may have in a variety of shapes and sizes, and include cylindrical, prismatic, or coin-type batteries, and may be thin film batteries or may be rather bulky in size. The structure and the manufacturing method of these batteries are well known in the art and will not be described in greater detail.

The shape of a rechargeable lithium battery according to one embodiment is not specifically limited and may include any shape such as cylindrical, coin-type, or pouch as long it operates as a battery.

### EXAMPLES

Hereinafter, embodiments are illustrated in more detail with reference to examples. However, the following are exemplary embodiments and are not limiting.

### Examples 1 to 13 and Comparative Examples 1 to 4

### Preparation of Electrolyte and Rechargeable Lithium Battery Cell

Ethylene carbonate (EC), dimethyl carbonate (DMC), and any one of ethyl acetate (EA), methyl acetate (MA), propyl acetate (PA), and ethylmethyl carbonate (EMC) were mixed in a volume ratio shown in the following Table 1 to provide an electrolyte with LiPF₆ having a concentration of 1.3M.

A positive active material of lithium-nickel-cobalt-manganese-based oxide (LiNi_{0.5}Co_{0.2}Mn_{0.3}O₂), a binder of polyvinylidene fluoride (PVDF), and a conductive material of carbon black were mixed at a weight ratio of 96:2:2 (LiNi_{0.5}Co_{0.2}Mn_{0.3}O₂: polyvinylidene fluoride:carbon black) and dispersed in N-methyl-2-pyrrolidone to provide a composition for a positive active material layer. The composition for a positive active material layer was uniformly coated on an aluminum foil having a thickness of 20 μm, dried, and compressed to provide a positive electrode.

A negative active material of artificial graphite and a binder of polyvinyl alcohol were mixed at a weight ratio of 98:2 (artificial graphite: polyvinyl alcohol) and dispersed in deionized water to provide a composition for a negative active material layer. The composition for a negative active material layer was uniformly coated on a copper foil having a thickness of 15 μm, dried, and compressed to provide a negative electrode.

The obtained positive electrode and negative electrode and a separator of polyethylene material having a thickness of 25 μm were wound and inserted into a cylinder can. Each of obtained electrolytes was injected therein to provide a rechargeable lithium battery cell. Each of the obtained rechargeable lithium battery cells was sequentially referred to as Examples 1 to 13 and Comparative Examples 1 to 4.

The following Table 1 shows the composition of electrolyte, the conductivity of electrolyte, and the viscosity of electrolyte, and the positive active mass density of each obtained rechargeable lithium battery cell.

The conductivity of electrolyte is measured using 712 conductometer equipment manufactured by Metrohm by applying the constant voltage to two electrodes immersed in electrolyte and flowing the applied voltage with current. The viscosity of electrolyte may be determined by flowing liquid and measuring the internal resistance by SV-10 equipment manufactured by AND. The positive electrode active mass density was determined by sampling the electrolyte, measuring the thickness, and weighing on a scale to calculate the density.

TABLE 1

| | Positive active | | | | EA, MA, PA | | |
|---|---|---|---|---|---|---|---|
| | mass density | LiPF₆ | EC | DMC | or EMC | Conductivity | Viscosity |
| | (g/cc) | (M) | (volume %) | (volume %) | (volume %) | (mS/cm) | (cP) |
| Example 1 | 3.4 | 1.0 | 20 | 70 | EA, 10 | 11.07 | 4.29 |
| Example 2 | 3.4 | 1.0 | 20 | 60 | EA, 20 | 11.50 | 4.09 |
| Example 3 | 3.4 | 1.0 | 20 | 50 | EA, 30 | 11.93 | 3.78 |
| Example 4 | 3.4 | 1.0 | 20 | 40 | EA, 40 | 12.42 | 3.43 |
| Example 5 | 3.4 | 1.0 | 20 | 30 | EA, 50 | 12.86 | 3.03 |
| Example 6 | 3.4 | 1.0 | 20 | 70 | MA, 10 | 11.19 | 4.23 |
| Example 7 | 3.4 | 1.0 | 20 | 30 | MA, 50 | 13.01 | 2.90 |
| Example 8 | 3.4 | 1.0 | 20 | 70 | PA, 10 | 10.74 | 4.42 |
| Example 9 | 3.4 | 1.0 | 20 | 30 | PA, 50 | 11.96 | 3.75 |
| Example 10 | 3.6 | 1.0 | 20 | 70 | EA, 10 | 11.07 | 4.29 |
| Example 11 | 3.6 | 1.0 | 20 | 30 | EA, 50 | 12.86 | 3.03 |
| Example 12 | 3.8 | 1.0 | 20 | 70 | EA, 10 | 11.07 | 4.29 |
| Example 13 | 3.8 | 1.0 | 20 | 30 | EA, 50 | 12.86 | 3.03 |
| Comparative | 3.4 | 1.0 | 20 | 70 | EMC, 10 | 10.28 | 4.48 |
| Example 1 | | | | | | | |
| Comparative | 3.4 | 1.0 | 20 | 40 | EMC, 40 | 9.12 | 4.51 |
| Example 2 | | | | | | | |
| Comparative | 3.4 | 1.0 | 20 | 20 | EA, 60 | 13.11 | 2.86 |
| Example 3 | | | | | | | |
| Comparative | 3.4 | 1.0 | 20 | 0 | EA, 80 | 13.59 | 2.57 |
| Example 4 | | | | | | | |

### Experimental Example 1

### Evaluation of Cycle-Life Characteristics of Rechargeable Lithium Battery

Each rechargeable lithium battery cell obtained from Examples 1 to 13 and Comparative Examples 1 to 4 was charged and discharged at room temperature (about 25° C.) for 300 cycles to evaluate room temperature cycle-life characteristics. The results are shown in the following Table 2.

The charging and discharging were performed by charging under the conditions of 0.8 C-rate and 4.2V at a cut off of 0.05 C-rate and pausing for 10 minutes, and then discharging under the conditions of 1 C-rate, 3.0V and paused for 10 minutes, which were repeated 300 times.

### Evaluation Basis for Room Temperature Cycle-Life Characteristics (Capacity Retention)

good: discharge capacity after charging and discharging for 300 cycles is greater than or equal to about 80% of initial discharge capacity

bad: discharge capacity after charging and discharging for 300 cycles is less than about 80% of initial discharge capacity

On the other hand, each rechargeable lithium battery cell obtained from Examples 1 to 13 and Comparative Examples 1 to 4 was charged and discharged at a low temperature (about 10° C.) for 100 cycles to evaluate the low temperature cycle-life characteristics, and the results are shown in the following Table 3.

The charging and discharging were performed by charging under the conditions of 0.7 C-rate, 4.2V and 0.05 C-rate or cut-off of 2 hours 30 minutes and pausing for 10 minutes, and then discharging under the conditions of 0.5 C-rate, 3.0V and paused for 10 minutes, which were repeated 100 times.

### Evaluation Basis of Low Temperature Cycle-Life Characteristics (Capacity Retention)

good: discharge capacity after charging and discharging for 100 cycles is greater than or equal to about 50% of initial discharge capacity

bad: discharge capacity after charging and discharging for 100 cycles is less than about 50% of initial discharge capacity

### Experimental Example 2

### Characteristics after being Allowed to Stand at a High Temperature

Each rechargeable lithium battery cell obtained from Examples 1 to 13 and Comparative Examples 1 to 4 was charged under the conditions of 0.5 C-rate, 4.2V, and cut-off of 3 hours and rested for 10 minutes and discharged under the condition of 0.2 C-rate, 2.75V to measure the initial discharge capacity.

Subsequently, each was charged under the conditions of 0.5 C-rate, 4.2V, cut-off for 3 hours and was allowed to stand at a high temperature (about 60° C.) for 30 days, and then discharged under the conditions of 0.2 C-rate, 2.75V to measure the discharge capacity after being allowed to stand at a high temperature.

Based on the measured discharge capacity, the characteristics after being allowed to stand at a high temperature were evaluated, and the results are shown in the following Table 4.

Evaluation Basis of Characteristics after being Δllowed to Stand (Capacity Retention) at High Temperature

good: discharge capacity after being allowed to stand at a high temperature is greater than or equal to about 85% of initial discharge

bad: discharge capacity after being allowed to stand at high temperature is less than about 85% of initial discharge

TABLE 2

| | Cycle-life at room temperature | | | |
|---|---|---|---|---|
| | Initial | 300th | | |
| | discharge | discharge | Capacity | |
| | capacity | capacity | retention | |
| | (mAh/g) | (mAh/g) | (%) | Evaluation |
| Example 1 | 2490 | 2288 | 91.9 | good |
| Example 2 | 2488 | 2312 | 92.9 | good |
| Example 3 | 2492 | 2325 | 93.3 | good |
| Example 4 | 2497 | 2336 | 93.6 | good |
| Example 5 | 2474 | 2343 | 94.7 | good |
| Example 6 | 2494 | 2303 | 92.3 | good |
| Example 7 | 2479 | 2406 | 97.1 | good |
| Example 8 | 2498 | 2186 | 87.5 | good |
| Example 9 | 2497 | 2312 | 92.6 | good |
| Example 10 | 2525 | 2273 | 90.0 | good |
| Example 11 | 2533 | 2361 | 93.2 | good |
| Example 12 | 2657 | 2365 | 89.0 | good |
| Example 13 | 2631 | 2421 | 92.0 | good |
| Comparative | 2494 | 1744 | 69.9 | bad |
| Example 1 | | | | |
| Comparative | 2485 | 1416 | 57.0 | bad |
| Example 2 | | | | |
| Comparative | 2484 | 2362 | 95.1 | good |
| Example 3 | | | | |
| Comparative | 2490 | 2402 | 96.5 | good |
| Example 4 | | | | |

TABLE 3

| | Cycle-life at low temperature | | | |
|---|---|---|---|---|
| | Initial | 100th | | |
| | discharge | discharge | Capacity | |
| | capacity | capacity | retention | |
| | (mAh/g) | (mAh/g) | (%) | Evaluation |
| Example 1 | 2275 | 1624 | 71.4 | good |
| Example 2 | 2284 | 1739 | 76.1 | good |
| Example 3 | 2283 | 1796 | 78.7 | good |
| Example 4 | 2239 | 1857 | 82.9 | good |
| Example 5 | 2280 | 1912 | 83.9 | good |
| Example 6 | 2253 | 1670 | 74.1 | good |
| Example 7 | 2253 | 2003 | 88.9 | good |
| Example 8 | 2256 | 1561 | 69.2 | good |
| Example 9 | 2252 | 1798 | 79.8 | good |
| Example 10 | 2344 | 1653 | 70.5 | good |
| Example 11 | 2369 | 1931 | 81.5 | good |
| Example 12 | 2472 | 1689 | 68.3 | good |
| Example 13 | 2481 | 1963 | 79.1 | good |
| Comparative | 2249 | 1121 | 49.8 | bad |
| Example 1 | | | | |
| Comparative | 2242 | 1032 | 46.0 | bad |
| Example 2 | | | | |
| Comparative | 2243 | 2006 | 89.4 | good |
| Example 3 | | | | |
| Comparative | 2276 | 2234 | 98.2 | good |
| Example 4 | | | | |

TABLE 4

| | Characteristics after being allowed to stand | | | |
|---|---|---|---|---|
| | at a high temperature | | | |
| | Initial | Discharge capacity | | |
| | discharge | after being | Capacity | |
| | capacity | allowed to stand | retention | |
| | (mAh/g) | (mAh/g) | (%) | Evaluation |
| Example 1 | 2621 | 2380 | 90.8 | good |
| Example 2 | 2615 | 2351 | 89.9 | good |
| Example 3 | 2621 | 2326 | 88.7 | good |
| Example 4 | 2611 | 2317 | 88.7 | good |
| Example 5 | 2619 | 2264 | 86.4 | good |
| Example 6 | 2610 | 2361 | 90.5 | good |
| Example 7 | 2611 | 2237 | 85.7 | good |
| Example 8 | 2606 | 2400 | 92.1 | good |
| Example 9 | 2618 | 2319 | 88.6 | good |
| Example 10 | 2714 | 2451 | 90.3 | good |
| Example 11 | 2720 | 2340 | 86.0 | good |
| Example 12 | 2853 | 2571 | 90.1 | good |
| Example 13 | 2889 | 2479 | 85.8 | good |
| Comparative | 2610 | 2468 | 94.6 | good |
| Example 1 | | | | |
| Comparative | 2612 | 2497 | 95.6 | good |
| Example 2 | | | | |
| Comparative | 2609 | 2204 | 84.5 | bad |
| Example 3 | | | | |
| Comparative | 2615 | 2168 | 82.9 | bad |
| Example 4 | | | | |

As shown in Table 2, Table 3, and Table 4, rechargeable lithium battery cells obtained from Examples 1 to 13 had excellent cycle-life characteristics at room temperature and low temperature and excellent characteristics after being allowed to stand at a high temperature.

One the other hand, rechargeable lithium battery cells obtained from Comparative Examples 1 and 2 had good characteristics after being allowed to stand at a high temperature but bad cycle-life characteristics at room temperature and low temperature; rechargeable lithium battery cells obtained from Comparative Examples 3 and 4 had good cycle-life characteristics at room temperature and low temperature but bad characteristics after being allowed to stand at a high temperature.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable lithium battery, comprising
a positive electrode having an active mass density of about 3.4 g/cc to about 4.0 g/cc;
a negative electrode; and
an electrolyte including a non-aqueous organic solvent including a compound represented by the following Chemical Formula 1 in an amount of about 10 volume % to about 50 volume % based on the total amount of the non-aqueous organic solvent:
CH₃COO—R¹, Chemical Formula 1
wherein R¹ is a C1 to C4 linear or branched alkyl group.

2. The rechargeable lithium battery of claim 1, wherein the non-aqueous organic solvent comprises a compound comprising a carbonate group.

3. The rechargeable lithium battery of claim 2, wherein the non-aqueous solvent comprises one selected from a compound comprising a cyclic carbonate group, a compound comprising a linear carbonate group, and combinations thereof.

4. The rechargeable lithium battery of claim 3, wherein the non-aqueous organic solvent comprises a compound comprising a cyclic carbonate group in an amount less than or equal to about 30 volume % based on the total amount of the non-aqueous organic solvent.

5. The rechargeable lithium battery of claim 3, wherein the non-aqueous organic solvent comprises a compound comprising a linear carbonate group in an amount of about 20 volume % to about 90 volume % based on the total amount of the non-aqueous organic solvent.

6. The rechargeable lithium battery of claim 3, wherein the non-aqueous organic solvent comprises a compound comprising a cyclic carbonate group and a compound comprising a linear carbonate group at a volume ratio of about 1:1 to about 1:9.

7. The rechargeable lithium battery of claim 1, wherein the electrolyte has a viscosity of about 2.90 cP to about 4.45 cP.

8. The rechargeable lithium battery of claim 1, wherein the electrolyte has conductivity of greater than or equal to about 10 mS/cm.

9. The rechargeable lithium battery of claim 1, wherein the positive active material comprises lithium-nickel-cobalt-manganese composite metal oxide.
